(19) United States
(12) Patent Application Publication
(10) Pub. No.: US 2002/0114031 A1
(43) Pub. Date: Aug. 22, 2002

(54) Ring configuration method, failure recovery method, and node address assignment method when configuring ring in network

(76) Inventor: Ryo Yamada, Tokyo (JP)

Correspondence Address: DICKSTEIN SHAPIRO MORIN & OSHINSKY LLP, 1177 Avenue of the Americas, New York, NY, 10036-2714, US

(21) Appl. No.: 10/067,747

(22) Filed: Feb. 8, 2002

(30) Foreign Application Priority Data
Feb. 21, 2001 (JP) 044381/2001

(51) Int. Cl. H04B 10/08; H04B 10/20; H04J 14/00

(52) U.S. Cl. 359/119; 359/110

(57) ABSTRACT

An easy and efficient failure recovery method in a mesh network is provided. A ring network consisting of a working system and a stand-by system is dynamically configured in response to a request for setting a path in a network in which nodes are interconnected by a plurality of optical fibers. If a failure occurs in the working system, nodes perform signaling for failure recovery to switch traffic to the stand-by system to recover from the failure. When the ring is configured, a ring map containing ring link information, information about ports at each node of channels constituting the ring, and node numbers locally assigned to the ring is provided to each of the nodes constituting the ring. A plurality of rings shares stand-by channel with each other.

### BACKGROUND OF THE INVENTION

1. Field of the Invention

The present invention relates to a ring configuration method, a failure recovery method in a network, and a node address assignment method when a ring is configured in a network as well as a node device used with these methods, and in particular to a failure recovery system in a network in which nodes are interconnected through a plurality of optical fibers to form a mesh network of a WDM (Wavelength Division Multiplex) system.

2. Description of the Related Art

A failure recovery in an optical fiber communication network has been accomplished by configuring a ring network such as SONET BLSR (SONET: Synchronous Optical Network; BLSR: Bi-directional Line-Switched Ring) defined in Bellcore GR-1230-CORE and ODU SPRing (ODU: Optical Data Unit; SPRing: Shared Protection Ring) discussed in G.841. As shown in FIG. 17A, for example, a ring network is a network in which nodes (indicated by A-E) are interconnected in a ring through two working fibers (W1, W2) in clockwise and counterclockwise directions and through two stand-by fibers (P1, P2) in directions opposite to these directions. In a normal state, the working fibers W1, W2 are used to perform bi-directional communication.

If a failure occurs between nodes B and C, for example, in such a ring network using the SONET BLSR system, the adjacent nodes B and C in the failed section detect the failure as shown in FIG. 17B and signaling for failure recovery between the nodes is performed so that the path is changed over to the stand-by path in the opposite direction, thereby recovering from the failure.

On the other hand, in an ODJ SPRing network system, terminal nodes A and C of traffic detect a failure as shown in FIG. 17C and signaling for failure recovery between the nodes is performed so that the path is changed over to the stand-by path in the opposite direction, thereby recovering from the failure.

The above-described failure recoveries are used in a ring network. In a mesh network (a network configuration consisting of a large number of nodes randomly disposed as shown in FIG. 10), a technology as disclosed in Japanese Patent Laid-Open No. 7-226736, for example, is used.

According to this technology, logical rings (indicated by thin solid lines) are fixedly set for each closed loop in a mesh network as shown in FIG. 18 and, in the event of a failure, signaling for failure recovery is performed between nodes to cause traffic to bypass a section by using each of these fixed logical rings as a unit, thereby recovering from the failure. For example, a path is set in the order, A-B-E-F-I, during transmission between nodes A and I. If in this state a failure occurs between nodes B and E, a recovery path A-B-A-D-E-F-I is set as indicated by a bold line in FIG. 18 to recover from the failure.

However, when a path across a number of rings is provided according to the above-described SONET BLSR and ODU SPRing systems, care must be taken to avoid a situation in which a failure becomes unrecoverable due to the failure at a node across rings. Therefore, when traffic extends across rings between nodes C and F as shown in FIG. 19 for example, a complicated path setting is required in such a manner that, in a normal sate, a signal is branched at node C to two paths, one is directly reaches node F and the other to C→D→J→F, then one of them is selected by a service selector 301 at node F. An extra bandwidth for C-D-J-F is also consumed.

A technology disclosed in Japanese Patent Laid-Open No. 7-226736 also causes complicated path setting in which, when a path across rings is set, the path should run through at least two nodes belonging to the nodes, and causes to waste bandwidths because separate protect bandwidths should be provided for each individual ring between nodes in two adjacent rings, like the SONET BLSR and ODU SPRing systems described above. This is because logical rings are fixedly set.

It is an object of the present invention to provide a ring configuration method that allows rings to be set dynamically and flexibly in a mesh network in which nodes are randomly located in mesh form to avoid complicated path setting and wasted bandwidths due to paths across rings, and a failure recover method using the ring configuration method, as well as a node device used therewith.

It is another object of the present invention to provide a novel node address assignment method for assigning a local node number (node address) to each of nodes constituting a ring in order to configure a dynamic ring readily and efficiently.

### BRIEF SUMMARY OF THE INVENTION

According to the present invention, there is provided a ring configuration method in a mesh network consisting of a plurality of nodes, each of the nodes having a cross-connection function, wherein a ring network (herein after called a ring) comprising a working path and a stand-by path is configured dynamically in response to a request for setting the working path.

The method is characterized in that a ring map containing at least information about the link of said ring, information about input/output ports at each of nodes along channels constituting said ring, and local node numbers (addresses) locally assigned to the nodes in said node is provided to the nodes constituting said ring.

The mesh network is a WDM (Wavelength Division Multiplex)-based optical fiber communication network. If anew ring to be configured is identical to an existing ring using the same wavelength as that of the new ring, the same node numbers as local node numbers locally assigned to nodes in the existing ring are assigned to the corresponding nodes in the new ring. If the new ring crosses or is adjacent to the existing ring, local node numbers different from those of the nodes in the existing node are assigned to the nodes in the new ring.

If a new ring to be configured is identical to or crosses an existing ring using the same wavelength of the new ring, a section of a stand-by path that is common to both of the rings is shared between the rings. The method is characterized in that a network management system centrally performs network map creation, path calculation, path setting, the generation of said ring map, and the provision of said ring map to each node by collecting information about connections between nodes and available channels.

The method is also characterized in that each node uses a routing protocol and signaling protocol to perform in a distributed manner the network map creation, path calculation, path setting, and generation of said ring map by collecting information about connections between nodes and available channels.

According to the present invention, there is provided a failure recovery method in a mesh network using the ring configuration method according to claim 1, wherein, if a failure occurs in the working path, nodes perform signaling for failure recovery to cause traffic to switch to the stand-by path to recover the network from the failure.

According to the present invention, there is provided a node address assignment method in dynamically configuring a new ring network including a working path in response to a request for setting the working path in a mesh network consisting of a plurality of nodes, each of the nodes having a cross-connection function, wherein: if the new ring to be configured is identical to an existing ring, the same node numbers (addresses) as those assigned locally to nodes in the existing ring are assigned to the corresponding nodes in the new ring.

If the new ring crosses or is adjacent to the existing ring, local node numbers different from those of the nodes in the existing node are assigned to the nodes in the new ring. The ring network consists of the working path and a stand-by path for the working path.

The mesh network is a WDM (Wavelength Division Multiplex)-based optical fiber communication network and the node address assignment method is characterized in that the determination whether the new ring is identical to, crosses, or is adjacent to the existing ring is made in terms of wavelength.

According to the present invention, there is provided a node device in a mesh network configured in such a way that a ring network (ring) consisting of a working path and a stand-by path is dynamically configured in response to a request for setting the working path, the node device comprising a ring map including at least information about the link of the ring, information about input/output port at each node of channels constituting the ring, and a local node number (address) assigned to each node constituting the ring.

An operation of the present invention will be described. A ring network consisting of a working system and stand-by system is configured dynamically in response to a path setting request in a network in which nodes are interconnected in mesh form with a plurality of optical fibers. If a failure occurs in the working system in the ring network, signaling is performed between nodes for error recovery to reroute traffic to the stand-by ring, thereby recovering from the failure.

To configure a ring network dynamically, ring management information identifying the ring is required. A ring map is defined for the ring management information. That is, a ring map containing ring link information, information about the ports of each nodes of channels constituting the ring, and node numbers (addresses) locally assigned to the ring is assigned to each of the nodes constituting the ring. A stand-by channel is shared between traffic in the same ring and traffic in a different ring, thereby achieving effective use of resources.

Basically the local node number (address) is uniquely assigned to each node in the ring map for dynamically configuring and managing the ring. However, if a new ring configured is identical to an existing ring, the same node number as a local node number (address) assigned locally to each node in the existing ring is assigned to each node in the new ring that corresponds to each node in the existing ring. If the new ring crosses or is adjacent to the existing ring, a node number different from the local node number of each node in the existing ring is assigned to each node in the new ring.

### BRIEF DESCRIPTION OF THE DRAWINGS

FIG. 1 schematically shows an exemplary system configuration of a network for illustrating a first embodiment of the present invention;

FIG. 2 shows an example of the configuration of a cross-connection device (node) used with the present invention;

FIGS. 3A and 3B show examples of the configurations of a signal processor in a node shown in FIG. 2;

FIG. 4 shows a state in which a path is set between nodes F and M;

FIG. 5 shows a state in which paths are set between nodes F and M and between nodes K and M;

FIG. 6 shows a state in which paths are set between nodes F and M and between nodes G and N;

FIG. 7 shows a failure between nodes G and H;

FIG. 8 shows a state after nodes G and H detects the failure and perform failure recovery;

FIG. 9 shows a state after nodes F and M detect a failure and perform failure recovery;

FIG. 10 schematically shows an exemplary system configuration of a network for illustrating a second embodiment of the present invention;

FIG. 11 shows another example of the configuration of the cross-connection device (node) used with the present invention;

FIG. 12 is a diagram of a ring map showing the state in FIG. 4;

FIG. 13 is a diagram of a ring map showing the state in FIG. 5;

FIG. 14 is a diagram of a ring map showing the state in FIG. 6;

FIG. 15 is a diagram of a ring map showing a case where a new ring is distinct from existing rings;

FIG. 16 is a diagram showing the numbers of input/output ports of a cross-connection device (node) shown in FIGS. 4 to 9;

FIGS. 17A, 17B, and 17C are diagrams for explaining a failure recovery method in SONET BLSR and ODU SPRing;

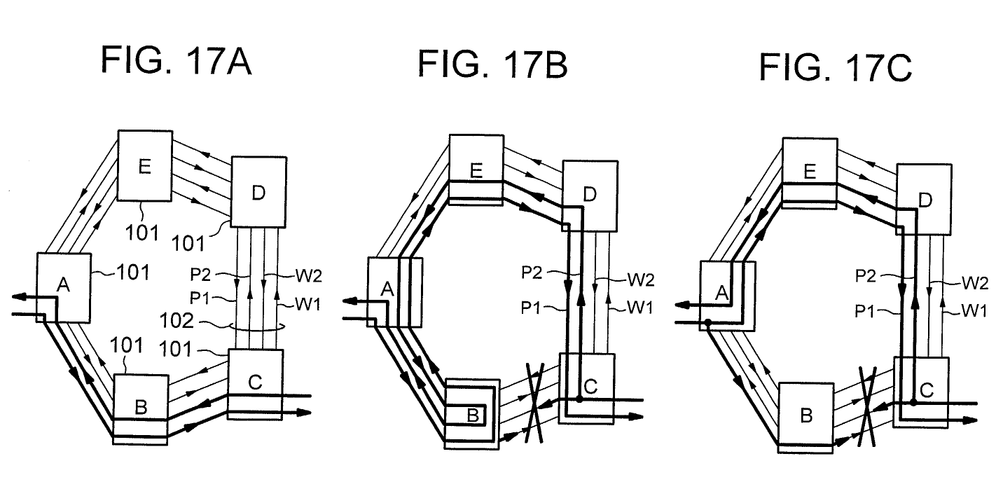

FIG. 18 is a diagram for explaining a failure recovery method described in Japanese Patent Laid-Open No. 7-226736; and

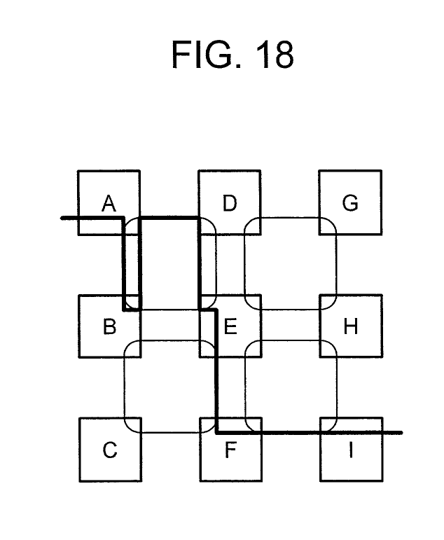

FIG. 19 is a diagram for explaining a method for setting a path across rings in SONET BLSR and ODU SPRing.

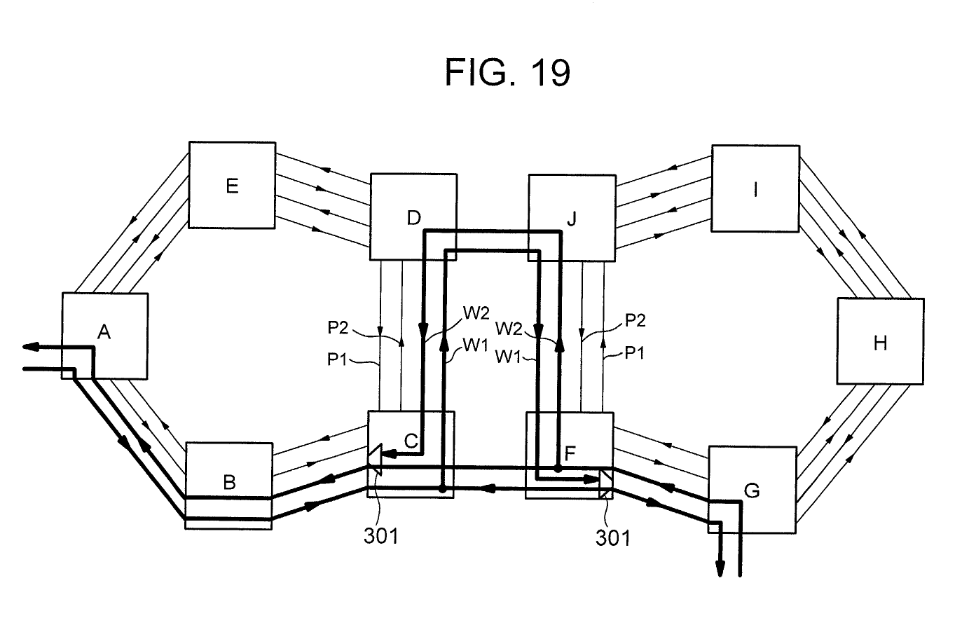

### DETAILED DESCRIPTION OF THE PREFERRED EMBODIMENTS

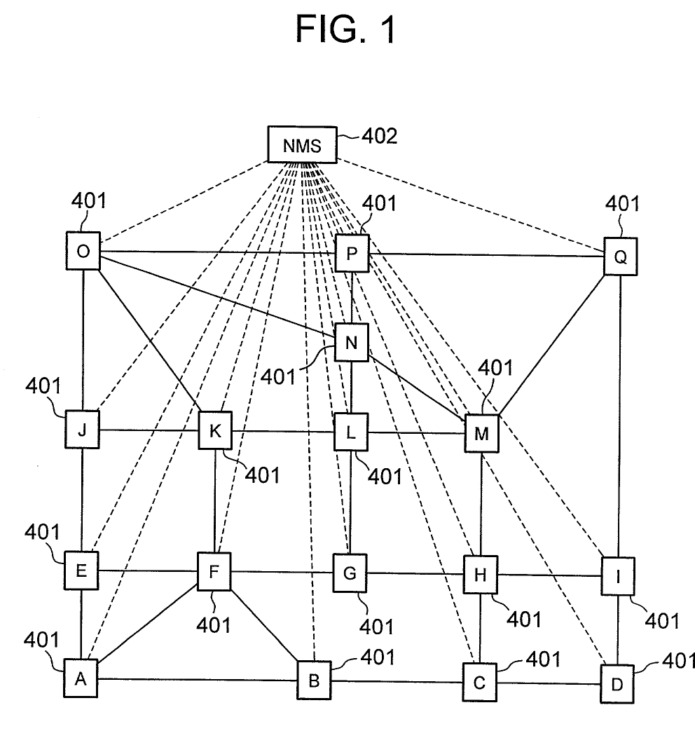

Embodiments of the present invention will be described with reference to the accompanying drawings. FIG. 1 schematically shows a configuration of a system to which a first embodiment of the present invention is applied and in which a large number of nodes 401 are randomly located in mesh form. Each node has a cross-connecting function and nodes are interconnected in mesh form by a plurality of optical fibers. Reference number 402 indicates a network management system (NMS) which centrally manages the network by collecting information about connections between nodes, information about available wavelengths, and other information to generate ring maps for managing rings to be configured dynamically and setting paths.

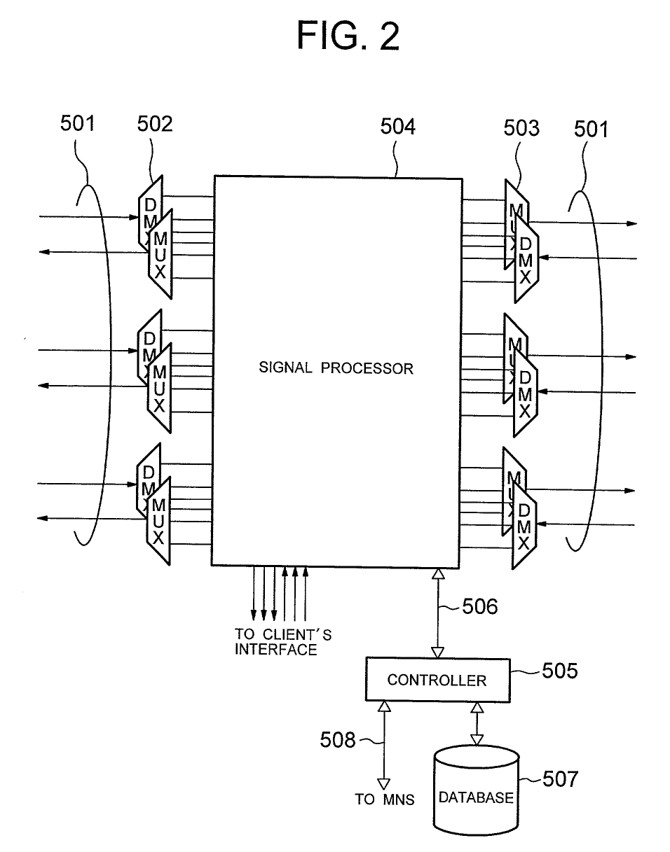

FIG. 2 shows an exemplary configuration of the cross-connection node 401 shown in FIG. 1. Reference number 501 indicates a transmission line optical fiber, 502 and 503 indicate a wavelength demultiplexer and multiplexer, respectively. Reference number 504 indicates a signal processor, which performs processes such as path setting and path switching of a signal and overhead processing of a signal. Reference number 505 indicates a node controller for accessing a signal overhead, controlling (506) a switch unit, accessing a database 507 and communicating (508) with an NMS.

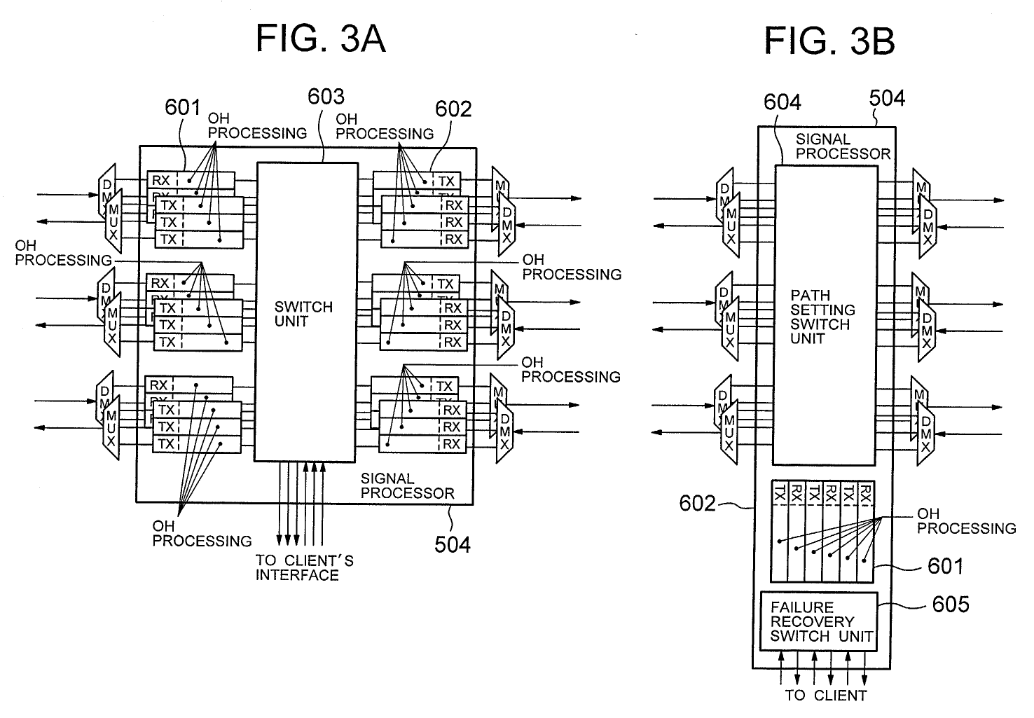

FIG. 3A shows an exemplary configuration of the signal processor 504 shown in FIG. 2. Reference number 601 indicates a signal receiver for receiving a signal and processing an overhead. Reference number 602 indicates a signal transmitter for sending a signal and processing an overhead. Reference number 603 indicates a switch unit for path setting and switching a signal. FIG. 3B shows another exemplary configuration of the signal processor 504 shown in FIG. 2. In this example, path setting is performed by a path setting switch unit 604 capable of handling a signal as a light and path switching for failure recovery is performed by a failure recovery switch unit 605.

A signal transmission scheme used with the present invention may be SDH (Synchronous Digital Hierarchy) specified in ITU-T recommendation G.707, SONET specified in T1.105 series, ODU discussed in G.709, or other schemes. These schemes assign bytes (the K1/K2 bytes in SDH/SONET and the APS (Automatic Protection System)/PCC (Protection Communication Control Channel) byte in ODU) for failure recovery signaling to an overhead and support failure recovery with a ring network. These failure recovery bytes and schemes are used with the present invention.

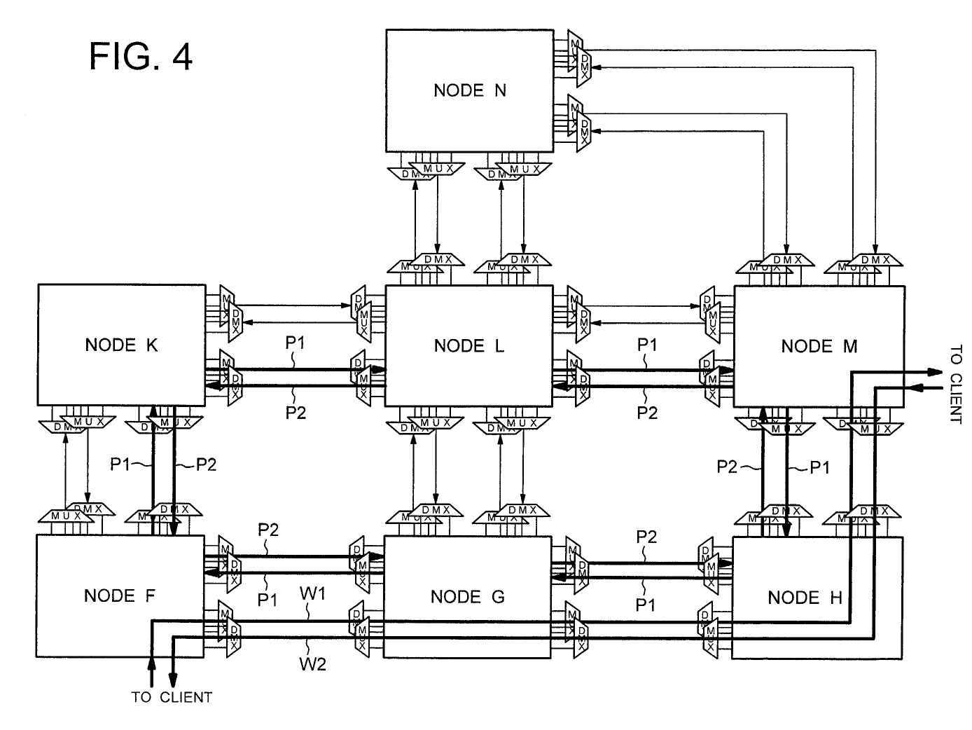

A case in which a request for setting a path between nodes F and M in a mesh network as shown in FIG. 4, is supposed. The NMS 402 shown in FIG. 1 uses a network map (which will be described later) to calculate an optimum path and determines that a path, F-G-H-M, is the optimum path. Then, the NMS 402 re-calculates an optimum path on the condition that the path or nodes do not overlap path F-G-H-M and calculates another path, F-K-L-M. As a result, a ring, F-G-H-M-L-K-F can be determined.

The NMS then performs path setting. Channels having the same wavelength (λ1) along F-G-H-M are set as working paths in two directions (W1, W2) as shown in FIG. 4 and λ1 between the nodes in the ring is reserved for stand-by paths (P1, P2) for W1 and W2 in the directions opposite to the working paths. When setting the paths, the NMS provides a ring map containing information such as link information of the ring and information about the ports of each port of each of nodes in channel constituting the ring. The ring map contains node numbers (addresses or IDs (identification numbers)) locally allocated to the ring.

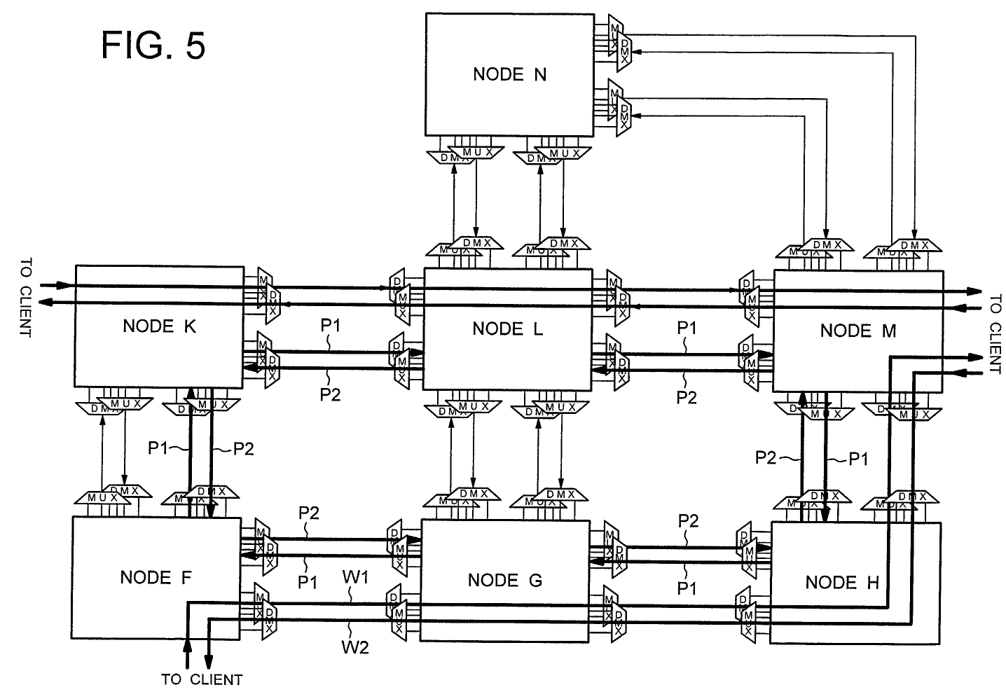

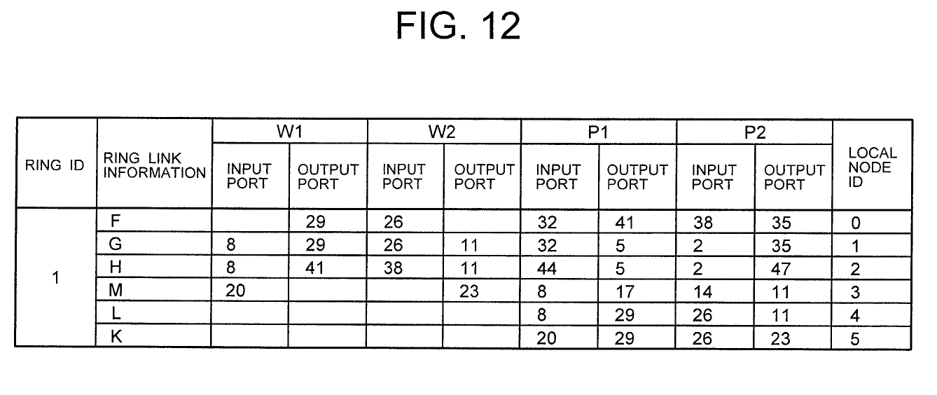

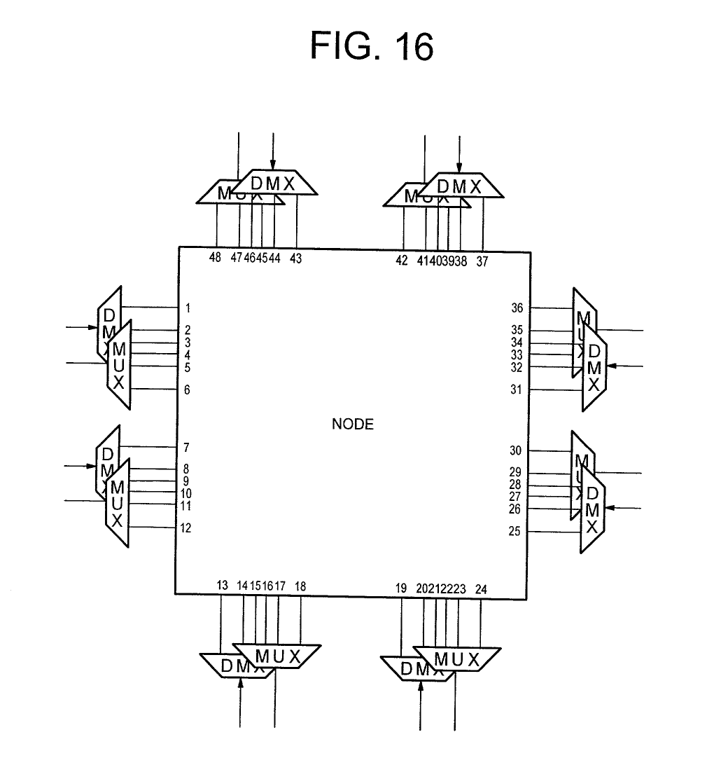

When the K1/K2 bytes of SDH/SONET or the APS/PCC bytes of ODU are used to recover a failure, each node is identified by its node number (for example, four bits in SDH/SONET, that is, one of numbers from 0 to 15). Therefore, these failure recovery bytes can be used by locally assigning the node numbers to the ring. An example of the ring map is shown in FIG. 12 and input/output port numbers of a representative node is shown in FIG. 16. The input/output port numbers shown in FIG. 16 are applied to all of FIGS. 5 through 9.

In the state shown in FIG. 4, a case where a new ring is configured in response to another path setting request, will be described below. A case in which the ring to be configured newly is identical to an existing ring (ring ID:1) having the same wavelength and a case in which the new ring crosses or is adjacent to or distinct from the existing ring will be described individually.

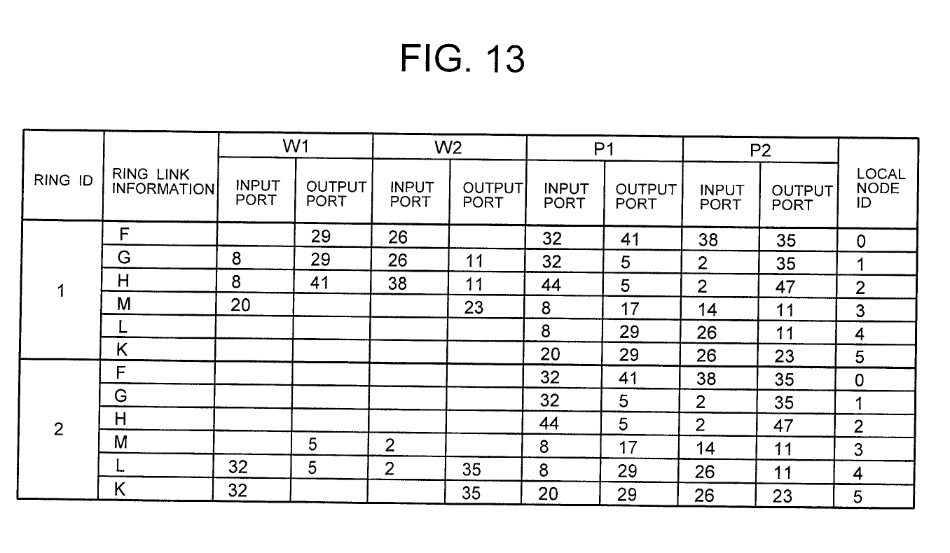

First, a case where the ring to be configured newly is the same as the existing ring having the same wavelength will be described. It is assumed that, for example, a request for setting a path between K and M is issued and path calculation is performed by using wavelength λ1 to determine K-L-M as an optimum path and K-F-G-H-M as another path. Then, the new ring will be F-G-H-M-L-K-F, which is identical to the existing ring (hereinafter indicated by a ring ID 1) in the ring map shown in FIG. 12. Therefore, local node IDs (identification numbers) and stand-by channels can be shared and the ring map including the new ring will be as shown in FIG. 13. The new ring is indicated by ring ID 2. FIG. 5 shows a state in which new paths are set between K and M.

A case where a ring to be configured newly crosses or is adjacent to an existing ring having the same wavelength will be described below. It is assumed that, for example, a request for setting a path between G and N is issued and path calculation is performed by using wavelength λ1 to determine G-L-N as an optimum path and G-H-M-N as another path. Then, the new ring will be G-H-M-N-L-G. Although there is no ring identical to the ring in FIG. 12, nodes, L, G, H, and M are shared with the ring having ring ID 1.

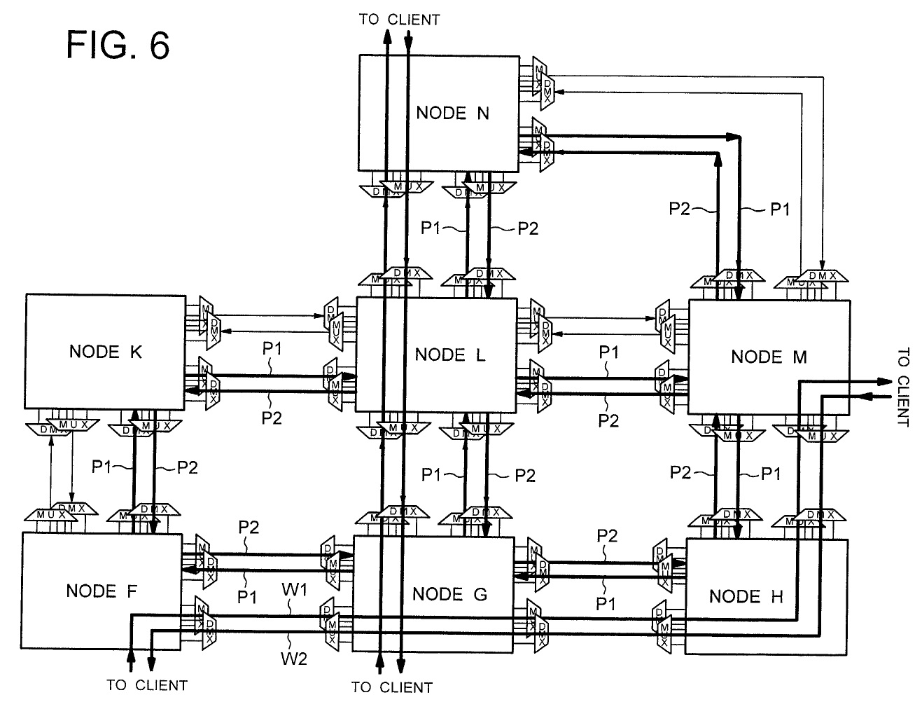

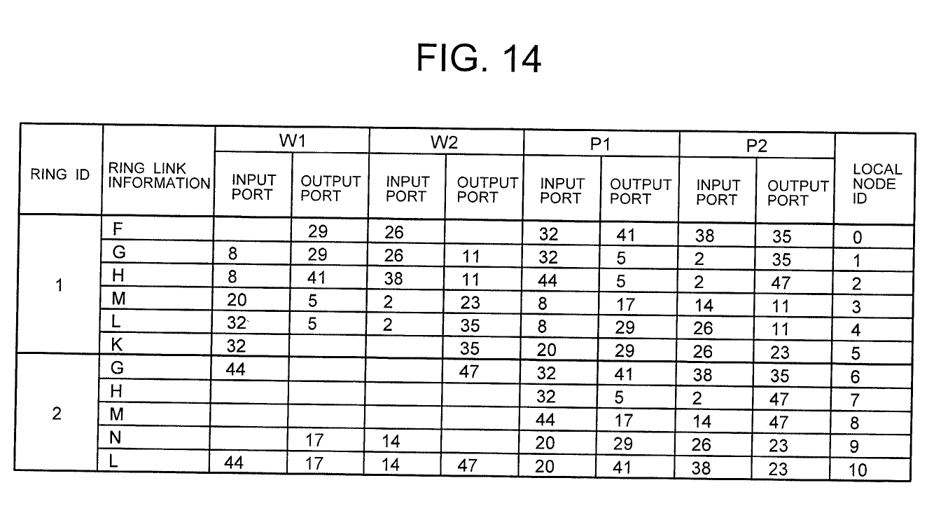

As described above, if there is a ring that shares nodes with a new ring, the local node ID's of the nodes of the new ring are assigned to numbers different from the local node ID's of the nodes of the new ring. In addition, stand-by channels between G and H and between H and M in the new ring are shared with the rings having ring ID 1. FIGS. 14 and 6 show the ring map and a state in which the new path is set between G and N.

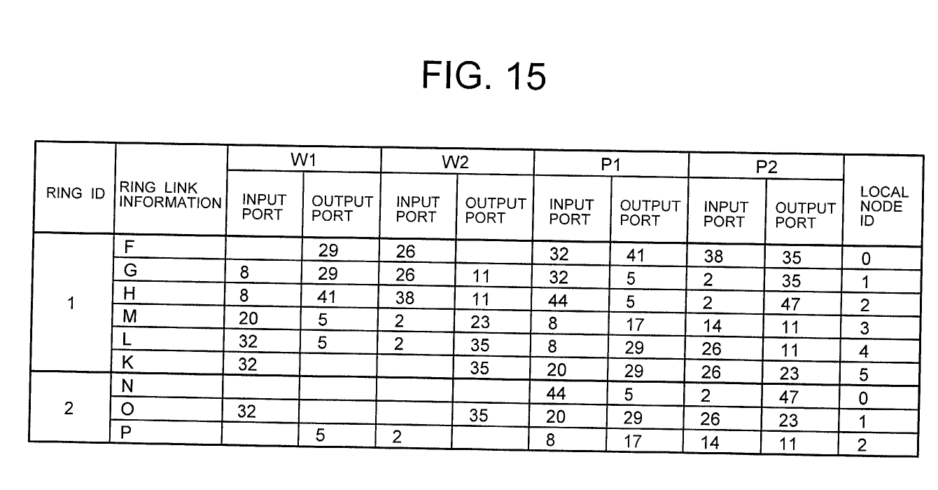

A case will be described below in which a ring to be configured newly is distinct from existing rings. It is assumed that, for example, a request for setting a path between O and P is issued from node O and path calculation is performed by using wavelength λ1 to determine O-P as an optimum path and O-N-P as another path. Then, the new ring will be N-O-P-N. In FIG. 12, there is no ring identical to this ring, nor a ring sharing a node with this ring. In this case, local node ID's can be assigned to the new ring independently of any existing rings and the ring map will be as shown in FIG. 15.

Finally, a case in which a node that performs failure detection and recovery is adjacent to a section where a failure such as a fiber break or a bit error rate (BER) increase has occurred and a case in which the node is a terminal node of the path will be described individually. It is noted that the failure detection may be accomplished by detecting a decrease in signal light power or level, a BER increase, S/N degradation, and a wavelength fluctuation, or any combinations of them as appropriate.

If a ring newly configured crosses or is adjacent to a plurality of existing rings, a ring can be selected on the basis of predetermined criteria such that the consumption of reserved resources is minimized or a ring length is shortest and so on. Then, the process describe above can be performed to assign local node ID's of the ring.

First, a case where a node adjacent to a failed section performs failure detection and recovery will be described. A sequence of operations for the failure recovery in this case is the same as a failure recovery method in the SONET BLSR.

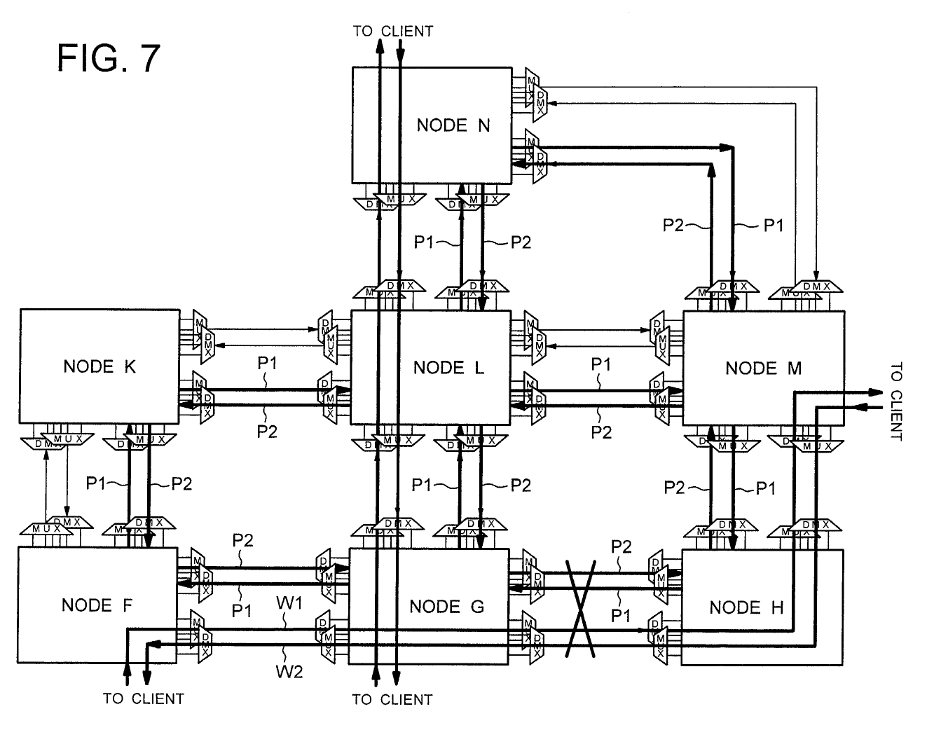

It is assumed that, in normal state, a path is set between nodes G and N and between nodes F and M as shown in FIG. 6 (a ring map in FIG. 14 is used). If a failure occurs between node G and H as shown in FIG. 7, node H (port 8) and node G (port 26) which are adjacent to the failed section detect the failure in W1 and W2, respectively. Failure recovery operations for W1 and W2 are the same, therefore only operations for W1 will be described.

Node H compares the number of port at which the failure has been detected with the ring map to determines that the failures has occurred in ring ID 1. Node H therefore inserts a message for path switching in a failure recovery byte and sends it to node G through output ports 5 and 47 of stand-by channels P1 and P2 of the ring having ring ID 1. The message contains the local node number (“1” in this embodiment) of node G as its destination, the local node number (“2” in this embodiment) of node H as its sender, and a switching request as the content of the message.

The message sent from node H through port 47 into P2 is received by node M. Node M compares a port at which it received the message with a ring map and with the local node number of the destination node and recognizes that it is a message concerning the ring having ring ID 1. It also recognizes that the message is not destined for node M itself and therefore transfers it to node L, which is the node next to node M, through output port 11 of P2 associated with the ring having ring ID 1. It also operates a switch so that the output port is connected with the input port of P1 associated with the ring having ring ID 1.

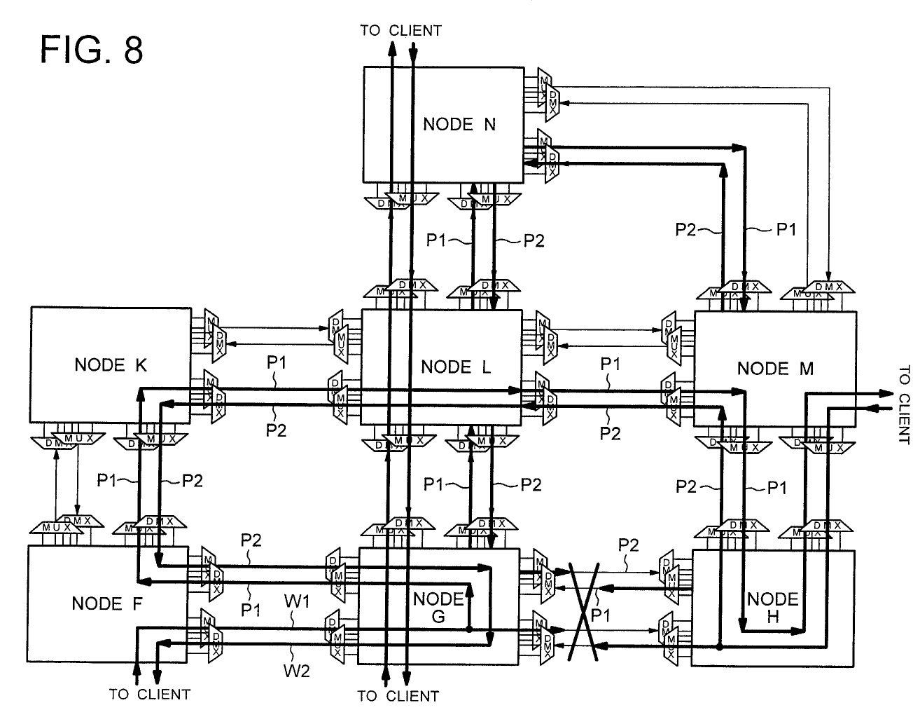

Similarly, nodes L, K, and F also transfers the message to their next nodes and node G receives the message. Node G compares the port at which it receives the message with the ring map and recognizes that it is a message concerning the ring having ring ID 1 and is a request made to node G for switching. Therefore node G bridges traffic on W1, which has been being sent from port 29 toward node H, to the stand-by channel P1 of node F and sends it from port 5. It also switches its receiving port to the stand-by channel P2 and receives a signal through port 2. The sequence of these operations is also performed for W2 and failure recovery is eventually accomplished as shown in FIG. 8.

The example has been described in which the stand-by channels (P1, P2) between nodes G and H are broken and failure recovery is accomplished by switching traffic to the stand-by channels in the direction opposite to working channels, like ring protection in SONET. If there is no failure in the stand-by channels between nodes G and H, failure recovery can be accomplished by switching to stand-by channels in the same direction as the working channels, like span protection in SONET.

A case where a terminal node of traffic performs failure detection and recovery will be described below. A sequence of operations for failure recovery in this case is the same as failure recovery method in ODU SPRing. It is assumed that a path is set between nodes G and N and between F and M as shown in FIG. 6 (a ring map is shown in FIG. 14). If a failure occurs between nodes G and H as shown in FIG. 7, node M (port 20) and node F (port 26), which are terminal nodes of the path, detect the failure in W1 and W2, respectively. Failure recovery operations for W1 and W2 are the same. Therefore only operations for W1 will be described.

Node M compares the number of port at which the failure has been detected with the ring map and recognizes that the failure occurs in the ring having ring ID 1. The node M therefore inserts a message for path switching in a failure recovery byte and sends it to node F through output ports 11 and 17 of protect channels P1 and P2 of the ring having ring ID 1. The message contains the local node number of node F as its destination, the local node number of node M as its sender, and a switching request as the content of the message.

The message sent from node M through port 11 into P2 is received by node L. Node F compares a port at which it received the message with the ring map and determines that it is a message concerning the ring having ring ID 1. It also recognizes that the message is not destined for node L itself and therefore transfers it to node K, which is the node next to node M, through output port 11 of P2. It also operates a switch so that the output port is connected with the input port of P1 associated with the ring having ring ID 1. Similarly, node K also transfers the message to the next node and node F receives the message.

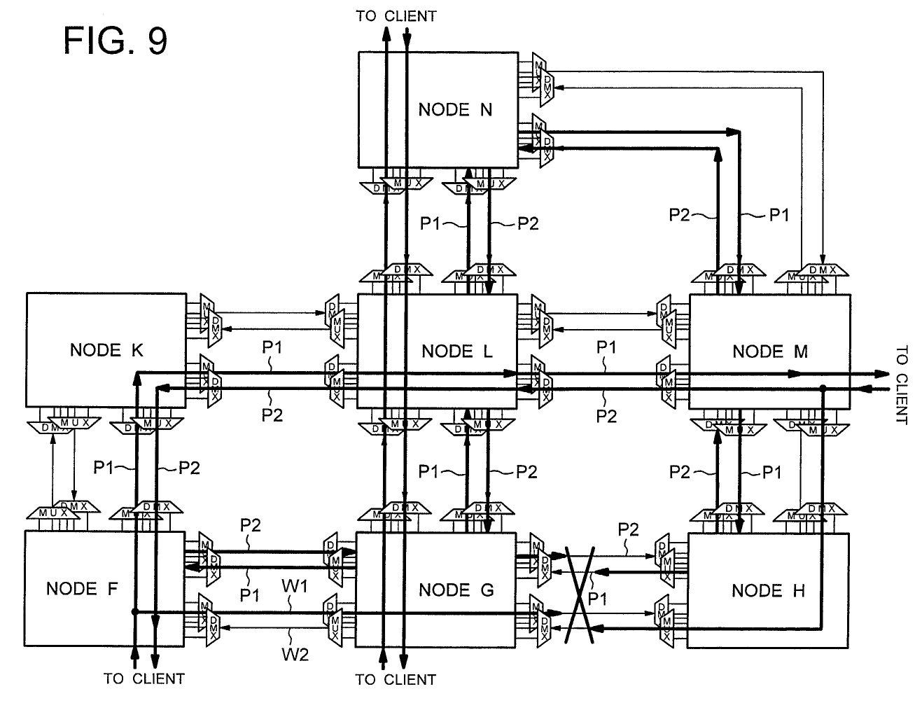

Node F compares the port number at which it receives the message with the ring map and recognizes that it is a message concerning the ring having ring ID 1 and is a request made to node F for switching. Therefore node F bridges traffic on W1, which has been being sent from port 29 toward node G, to the stand-by channel P1 and sends it from port 41. It also switches its receiving port to the stand-by channel P2 and receives a signal through port 38. The sequence of these operations is also performed for W2 and failure recovery is accomplished as shown in FIG. 9.

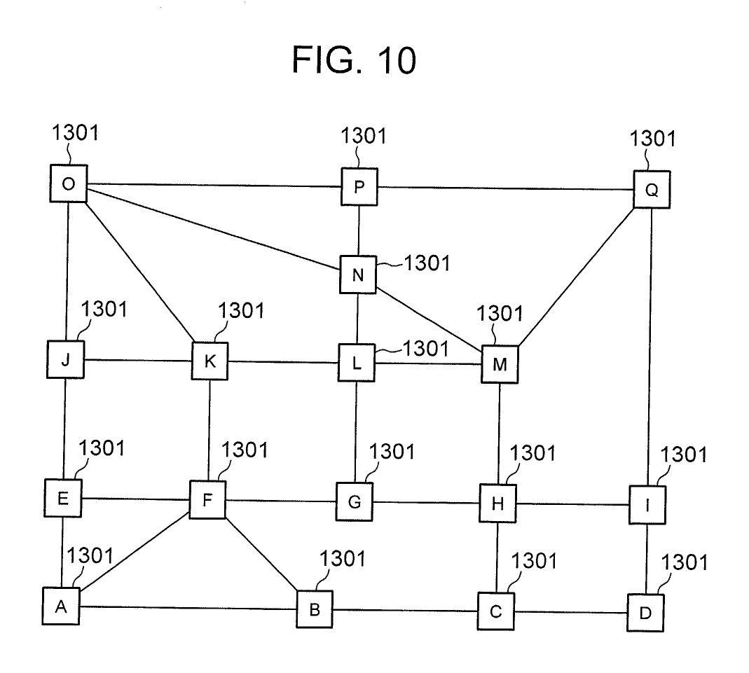

A second embodiment of the present invention will be described below with respect to a mesh network shown in FIG. 10. Reference number 1301 indicates cross-connection nodes interconnected by a plurality of optical fibers. In this embodiment, there is not an NMS 402 shown in FIG. 1. Therefore, it is required that a routing protocol is operated to generate a network map and a signaling protocol is operated to set a path between nodes in a distributed manner.

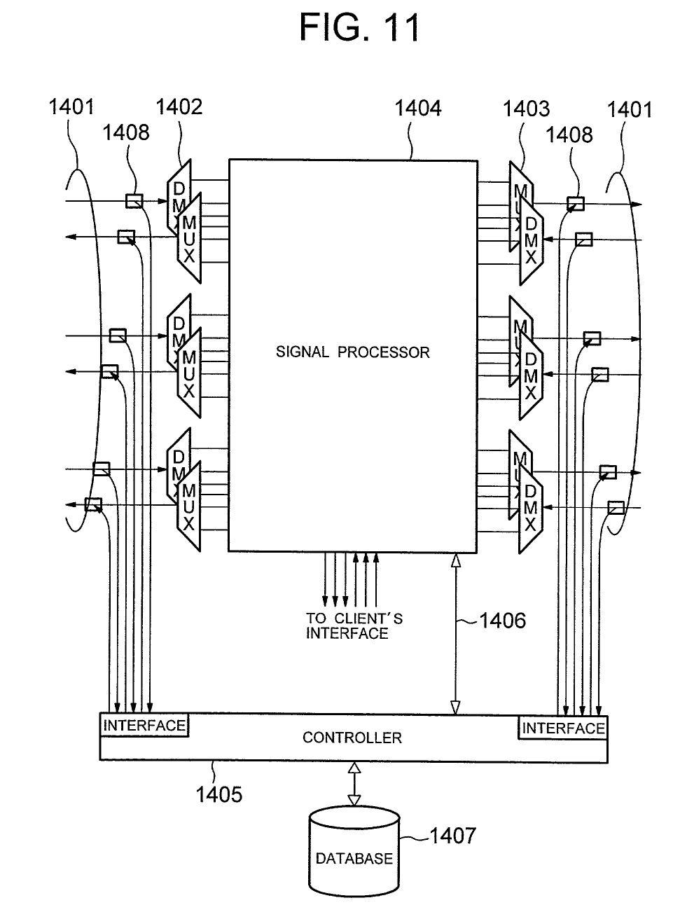

Therefore, a control channel is required for operating the routing protocol and path setting signaling protocol. The control channel may be data communication channel (such as SDH Data Communication Channel (DCC) and ODU General Communication Channel (GCC)) allocated to the overhead in a data signal. Alternatively, one wavelength of the data signal may be used for the control signal, or a wavelength in a band different from that of the data signal as shown in FIG. 11. It may be a electric signal.

An optical signal having a certain wavelength is used as the control signal and a WDM (Wavelength Division Multiplexing) Coupler 1408 multiplexes and demultiplexes the control signal and a data signal in FIG. 11. The band of the control signal may be a 1,51 μm band if the data signal is a 1.55 μm band signal, for example. The control channel should be terminated at each node.

Reference number 1401 in FIG. 11 indicates optical fibers, 1402 indicates optical demultiplexers, 1403 indicates optical multiplexers, 1404 indicates a signal processor of node, 1405 indicates a controller, 1406 indicates the control signal, and 1407 indicates a database.

In the network shown in FIG. 10, the each node uses a control channel to operate a routing protocol (see IETF Internet Draft “draft-wang-ospf-isis-lambda-te-routing-00.txt”, for example) such as an extension of OSPF (Open Shortest Path First) and generate a network map containing information about connections between nodes and available wavelengths, and stores it in the database.

When a path-setting request is issued, a node that receives the request performs optimum path calculation to calculate a ring. For actual path setting, a signaling protocol (see OIF Contribution “oif2000.179”, for example) such as an extension of RSVP-TE (Resource Reservation Protocol with extensions for Traffic Engineering) or CR-LDP (Constraint-based Routing Label Distribution Protocol) may be used.

When signaling for path setting is performed, the ring map is provided to the nodes constituting the ring. The ring map is required for a node to configure a new ring. It can be distributed to all the nodes in the network by using the routing protocol or a node can obtain it by performing signaling with nodes constituting a ring after calculating the ring by optimum path calculation. Because each node has the ring map, failure recovery can be performed in a manner similar to the first embodiment.

As described above, according to the present invention, a ring network is dynamically configured with working paths and stand-by paths in response to a request for setting a path in a mesh network that uses cross-connections and the ring is used to perform failure recovery, thereby eliminating a complex process involved in setting a path across rings. In addition, a ring map for ring management that is required for dynamically configuring the ring is provided to each node, which allows a plurality of rings to share stand-by channels, thereby enabling an efficient use of bandwidths.

The management of the local node numbers (addresses) of nodes in a ring map for ring management according to the present invention has advantages that nodes can be managed easily and each node can readily and correctly identify a ring to which it belongs during a failure recovery process because if a new ring is identical to an existing ring, the same addresses as those of nodes in the existing ring are assigned to the corresponding nodes in the new ring, and, if a new ring crosses or is adjacent to an existing ring, addresses different from those of nodes in the existing ring are assigned to nodes in the new ring.

What is claimed is:

1. A ring configuration method in a mesh network consisting of a plurality of nodes, each of said nodes having a cross-connecting function, wherein a ring network (herein after called a ring) comprising a working path and a stand-by path is configured dynamically in response to a request for setting said working path.

2. The ring configuration method according to claim 1, wherein a ring map containing at least information about the link of said ring, information about input/output ports at each of nodes along channels constituting said ring, and local node numbers (addresses) locally assigned to the nodes in said ring is provided to the nodes constituting said ring.

3. The ring formation method according to claim 1, wherein said mesh network is a WDM (Wavelength Division Multiplex)-based optical fiber communication network.

4. The ring configuration method according to claim 3, wherein, if a new ring to be configured is identical to an existing ring using the same wavelength as that of said new ring, the same node numbers as node numbers locally assigned to nodes in said existing ring are assigned to the corresponding nodes to each node of said existing ring in said new ring.

5. The ring formation method according to claim 3, wherein, if said new ring crosses or is adjacent to said existing ring using in the same wavelength, local node numbers different from those of the nodes in said existing ring are assigned to the nodes in said new ring.

6. The ring configuration method according to claim 3, wherein a new ring to be configured is identical to or crosses an existing ring using the same wavelength of the new ring, a section of a stand-by path that is common to both of the rings is shared between the rings.

7. The ring configuration method according to claim 1, wherein a network management system centrally performs network map generation, path calculation, path setting, generation of said ring map, and the provision of said ring map to each node, by collecting information about connections between nodes and available channels.

8. The ring configuration method according to claim 1, wherein each node uses a routing protocol and signaling protocol to perform in a distributed manner network map generation, path calculation, path setting, and generation of said ring map, by collecting information about connections between nodes and available channels.

9. A failure recovery method in a mesh network using the ring configuration method according to claim 1, wherein, if a failure occurs in said working path, nodes perform signaling for failure recovery to cause traffic to switch to said stand-by path to recover the network from the failure.

10. A node address assignment method in dynamically configuring a new ring network including a working path in response to a request for setting the working path in a mesh network consisting of a plurality of nodes, each of said nodes having a cross-connecting function, wherein: if the new ring to be configured is identical to an existing ring, the same node numbers (addresses) as those assigned locally to nodes in said existing ring are assigned to the corresponding nodes to said existing ring in said new ring.

11. The node address assignment method according to claim 10, wherein, if said new ring crosses or is adjacent to said existing ring, local node numbers different from those of the nodes in said existing ring are assigned to the nodes in said new ring.

12. A node address assignment method in dynamically configuring a new ring network including a working path in response to a request for setting the working path in a mesh network consisting of a plurality of nodes, each of said nodes having a cross-connecting function, wherein if the new ring to be configured crosses or is adjacent to said existing ring, local node numbers different from those of the nodes in said existing ring are assigned to the nodes in said new ring.

13. The node address assignment method according to claim 10, wherein said ring network is a ring comprising said working path and a stand-by path for said working path.

14. The node address assignment method according to claim 10, wherein said mesh network is a WDM (Wavelength Division Multiplex)-based optical fiber communication network.

15. The node address assignment method according to claim 14, wherein the determination whether said new ring is identical to, crosses, or is adjacent to said existing ring is made in terms of wavelength.

16. A node device in a mesh network configured in such a way that a ring network (ring) consisting of a working path and a stand-by path is dynamically configured in response to a request for setting said working path, said node device comprising a ring map including at least information about the link of said ring, information about input/output port at each node of channels constituting said ring, and a local node number (address) assigned locally to each node constituting said ring.

17. The node device according to claim 16, wherein said mesh network is a WDM (Wavelength Division Multiplex)-based optical fiber communication network.

18. The node device according to claim 17, wherein, if a new ring is identical to an existing ring using the same wavelength, in said ring map, the same node numbers as node numbers locally assigned to nodes in said existing ring are assigned to the corresponding nodes to said existing ring in said new ring.

19. The node device according to claim 17, wherein, if said new ring crosses or is adjacent to said existing ring using the same wavelength, in said ring map, local node numbers different from those of the nodes in said existing ring are assigned to the nodes in said new ring.

20. The node device according to claim 16, wherein a management system managing the network centrally manages and provides said ring map to each node device.

21. The node device according to claim 16, wherein each node uses a routing protocol and signaling protocol to perform in a distributed manner generation of the network map, path calculation, path setting, and generation of said ring map by collecting information about connections between nodes and available channels.
